(19) United States
(12) Patent Application Publication
(10) Pub. No.: US 2014/0216780 A1
(43) Pub. Date: Aug. 7, 2014

(54) MULTIPLE ELECTRICAL SOURCE HOUSING

(71) Applicant: ROBERT YANNIELLO, Asheville, NC (US)

(72) Inventor: ROBERT YANNIELLO, Asheville, NC (US)

(21) Appl. No.: 13/761,651

(22) Filed: Feb. 7, 2013

(51) Int. Cl. H02G 5/06

(52) U.S. Cl. CPC H02G 5/06
USPC 174/95

(57) ABSTRACT

A busway is described herein that is configured for receipt of plural power sources. The busway device comprises a first plurality of busbars in a spaced apart relationship, with the width, thickness, and spacing of the busbars configured for receipt of a first power source. The first plurality of busbars is contained in a first housing. The device further includes a second plurality of busbars in a spaced apart relationship, with the width, thickness, and spacing of the busbars configured for receipt of a second power source. The second plurality of busbars is contained in a second housing and electrically isolated from the first plurality. The first housing is configured for adjacent placement and connection to the second housing.

### BRIEF DESCRIPTION OF THE DRAWINGS

For a more complete understanding of the present invention, including its features and advantages, reference is now made to the detailed description of the invention taken in conjunction with the accompanying drawing in which:

FIG. 1 illustrates a side perspective view of an embodiment of the multiple power source busway according to the current invention;

FIG. 2A illustrates a representative partial block diagram of the embodiment of FIG. 1;

FIG. 2B illustrates a representative partial block diagram of the embodiment of FIG. 1;

FIG. 2C illustrates a representative partial block diagram of the embodiment of FIG. 1;

FIG. 3 illustrates a bus plug mated with an embodiment of the current invention;

FIG. 4 illustrates plural bus plugs mated with an embodiment of the current invention;

FIG. 5 illustrates a block diagram of a representative power distribution at a facility;

FIG. 6A illustrates a side view of an alternate embodiment of the multiple power source busway according to the current invention;

FIG. 6B illustrates a side view of an alternate configuration of the embodiment of

FIG. 6a;

FIG. 7 illustrates a top perspective view of a bridge joint of yet another alternate embodiment of the multiple power source busway according to the current invention; and

FIG. 8 illustrates a side view of the bridge joint of FIG. 7; and

FIG. 9 illustrates a top perspective view of yet another alternate embodiment of the multiple power source busway according to the current invention.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

Electrical power distribution, or busway systems, are used to distribute electrical power throughout buildings, particularly commercial or industrial type buildings where demand is high. One representative type of building is a server farm, where a group of networked servers are housed in one facility. Generally, a busway includes a number of busway sections which are connected to one another by busway joints or bridges. Typically, each busway section includes housing that encloses a plurality of busbars which may be phase busbars, neutral busbars, or ground busbars depending on the particular application. High-amp busways, generally utilizing larger busbars, are employed for applications requiring current capacity of approximately 600 amperes or higher. For applications requiring less current, typically 100 to 800 amperes, low-amp busways are employed. Lower current capacity requirements generally employ busbars which are smaller in width and/or height. Spacing between busbars generally varies according to the voltage.

The current busways are deficient in that the busways receive power from only a single electrical source, leaving the user to install multiple busways in an environment where plural power sources, perhaps of differing voltage or amperage, are desired at a single location.

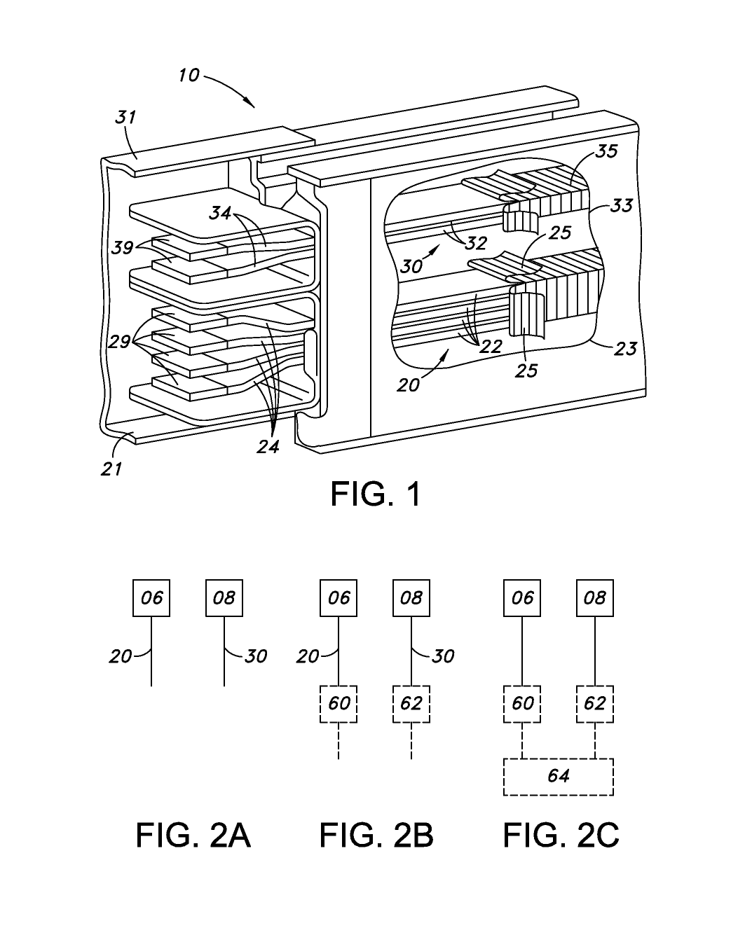

Now referring to FIG. 1, an embodiment of the multiple power source busway 10 is disclosed. It includes a first plurality 20 of busbars 22 and a second plurality 30 of busbars 32. This embodiment describes a first plurality 20 of busbars 22 and a second plurality 30 of busbars 32 configured for adjacent placement, with each plurality 20 and 30 operable to receive current from a separate power source 06 and 08 (shown in FIGS. 2A-2C).

The first plurality 20 of busbars 22 is configured to receive a first current 06 having a configured amperage, voltage, and waveform. The busbars 22 are preferably planar and disposed within a first busway housing 21 in a generally parallel and spaced apart relationship. Each busbar 22 is optionally coated with an insulative layer 24. The insulative layer 24 on each busbar 12 prevents electrical contact or arcing between the busbars 22. Each busbar 22 also presents a centerline 26 along its length. It should be noted that the centerline may be abstract in order to accommodate such configurations as hollow busbars in order to minimize “skin effect.” In the preferred embodiment, the first plurality 20 busbars 22 share a similar first centerline-to-centerline spacing 28. The first centerline-to-centerline spacing 28, thickness, width, and composition of the first plurality 20 of busbars 22 are configured according to the first power source 06. Where the first power source is of high amperage, the busbars 22 may have a higher thickness or width. The bars are preferably composed of copper or aluminum, but can be composed of other conducting material known in the art.

The proximal ends of the first plurality 20 of busbars 22 are shaped to receive the first power source 06. The distal region of the first plurality 20 of busbars 22 is configured to mate with bus bridges, bus plugs, appliances, or similar devices. The distal region of the busbars 22 includes conductive fingers 29 in order to facilitate mating and electrical communication with other devices. Additionally, the busbar 22 spacing may change in order to facilitate engagement with other devices.

The second plurality 30 of busbars 32 is similar to the first plurality 20 of busbars 22 and configured to receive a second current 08 having a second amperage, voltage, and/or waveform. The busbars 32 are also preferably planar and disposed within a second busway housing 31 in a generally parallel and spaced apart relationship. Each busbar 32 is optionally coated with an insulative layer 34 in order to prevent electrical contact or arcing between the busbars 32. Each busbar 32 also presents a centerline 36. In the preferred embodiment, the second plurality 30 of busbars 32 share a similar second centerline-to-centerline spacing 38. The second centerline-to-centerline spacing 38, thickness, width, and composition of the second plurality 30 of busbars 32 are configured according to the second power source 08. Where the second power source is of higher amperage, the busbars 32 have a higher thickness or width. The bars are also preferably composed of copper or aluminum.

The proximal ends of the second plurality 30 of busbars 32 are shaped to receive the second power source 08. The distal portions of the first plurality 30 of busbars 32 are configured to mate with bus bridges, bus plugs, appliances, or similar devices. The busbars 32 include conductive fingers 29 and 39 in order to facilitate mating and electrical communication with other devices. Additionally, the busbar 32 spacing may change in order to facilitate engagement with other devices.

Now referring to FIGS. 2A, 2B and 2C, partial block diagrams are depicted. The block diagrams represent the major portions of the two circuits. In a first circuit, a first power source 06 is provided. The first power source 06 is in communication with the first plurality 20 of busbars 22. The first plurality can include a single segment of busbars 22 or can include multiple segments joined by a bus bridge or the like. The distal ends of the first plurality 20 of busbars 22 having the conductive fingers 29 are free to engage to appliances 60 and 64 or other components 60 and 64.

A similarly configured electrically isolated, but physically adjacent, second circuit adapted for receipt of a second power source 08 is provided. The second power source 08 is in electrical communication with the second plurality 30 of busbars 32. The second plurality can include a single segment of busbars 32 or can include multiple segments joined by a bus bridge or the like. The distal ends of the second plurality 30 of busbars 32 having the conductive fingers 39 are free to engage to an appliance 62 64 or other component 62 64.

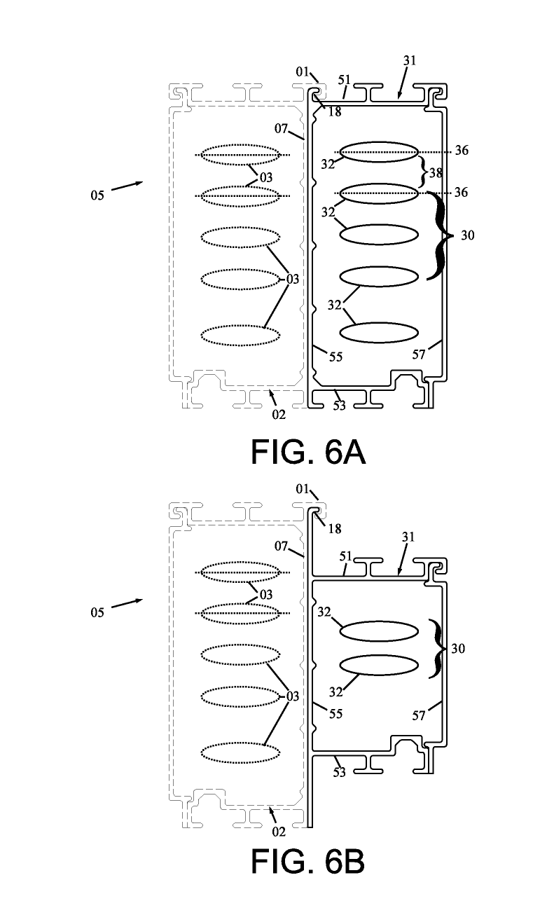

Still referring to FIG. 1, the busway device 10 includes housings 21 and 31. The housings 21 and 31 bound each plurality of busbars and present a barrier to external contact to each of the pluralities 20 and 30 of busbars 22 and 32 and optionally present a magnetic barrier. Each housing 21 and 31 preferably includes a plurality of generally planar members although they may be shaped as required for a particular use. Now referring to FIG. 6A, in these embodiments, each housing 21 and 31 includes a generally planar top member 51, a generally planar bottom member 53, a generally planar first sidewall member 55, and a generally planar second sidewall member 57. The top member 51, bottom member 53, first sidewall member 55 and second sidewall member 57 are joined lengthwise to define an enclosed space wherein the pluralities 20 and 30 of busbars 22 and 32 may be enclosed. The members 51, 53, 55 and 57 may be joined in different configurations. For example, the members 51, 53, 55 and 57 can be welded, snap fit, hingedly joined, slidably joined, removably joined, mechanically fastened, or other methods of joinder. The members 51, 53, 55 and 57 are preferably composed of non-magnetic, heat dissipating material such as aluminum. One configuration is composed of aluminum and includes the bottom member 53 and the sidewall members 55 57 joined in a U-shaped configuration with the top member 51 hingedly joined. Additional disclosures of housing configurations are well known in the art.

The housings 21 and 31 are configured for adjacent placement. FIG. 1 depicts vertical adjacent placement of the housings 21 and 31, while FIGS. 6A and 6B depict horizontal adjacent placement. First housing 21 can be mechanically or chemically joined to the second housing 31. Nonexclusive means of mechanical joinder include bolting, screwing, welding, snap locks, or slidable engagement in channels on the outer surface of the housing. In an exemplary configuration, a member 51, 53, 55, or 57 of the first housing 21 is also a member of the second housing 31. For example, the bottom member 53 of the first housing 21 dually serves as the top member 51 of the second housing 31.

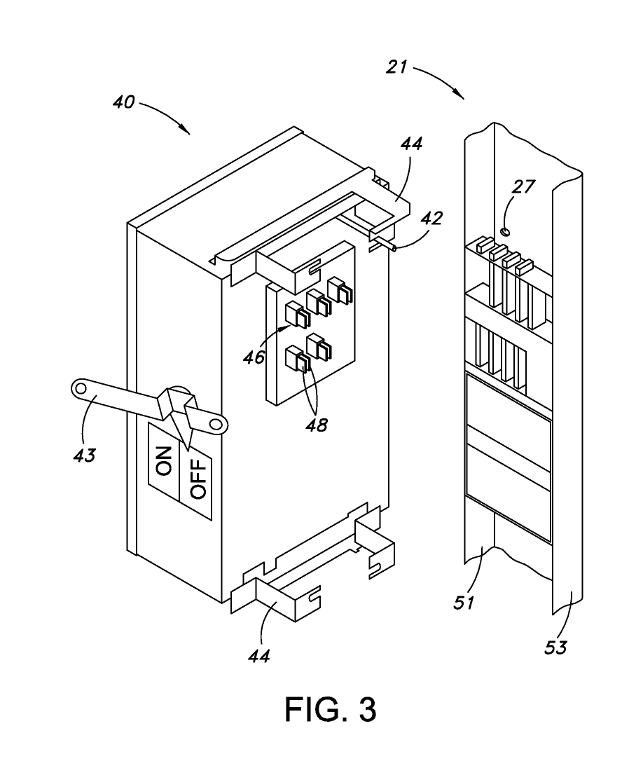

The bus way system 10 provides load access from a power source 06 08 alternate to the conductive fingers 29 and 39. The alternate structures can include sockets, bus plugs, or other means known in the art. A bus plug generally includes an electrical box containing a protective device, such as a circuit breaker or a fuse, and a switch. Referring specifically to FIG. 3, a bus plug 40 and housings 21 and 31 are depicted. The housings 21 and 31 optionally present an opening defining windows not shown. The window enables physical access to the plurality 20 and 30 of busbars 22 and 32 contained therein.

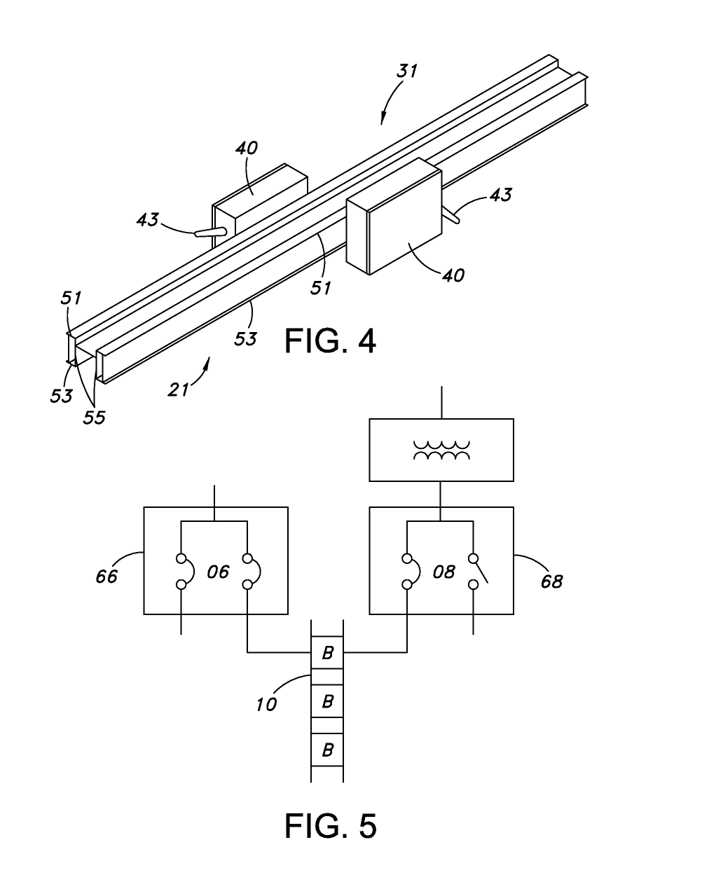

The bus plug 40 includes a rear surface having at least one mechanical connector 46, which provides for removably, mechanically attaching the bus plug 40 to the busway 10. The depicted mechanical connector 46 includes a pair of opposing tabs 48 spaced apart about the width of the corresponding busbar 22 and 32 extending distally from the rear surface of bus plug 40. A tensioner not shown provides biasing force for the tabs to maintain contact with a busbar 22 and 32 in order to allow for flow of electrical current from the busbar 22 and 32 to a load from the bus plug 40. Further, the tensioner not shown provides registration with the busbars 22 and 32. Thus the mechanical connectors 46 of the bus plug 40 can be aligned with the busbars 22 and 32 through the window not shown and slidably engaged to the busbars 22 and 32 in order to draw load from them. Referring specifically to FIG. 4, a first bus plug 40 is depicted engaged to the first housing 21 drawing load from the first power source 06 and a second bus plug 40 engaged to the second housing 31 drawing load from the second power source 08.

Now referring specifically to FIGS. 6A and 6B, an alternate embodiment configured for adjacent placement joinder to an existing single source busway 05 is disclosed. A current single source busway 05 having a plurality 04 of busbars 03 enclosed in a housing 02 with a face 07 on its outer surface is provided. The depicted current single source busway 05 includes a channel 01 extending lengthwise along its housing 02. The plurality 04 of busbars 03 is configured to receive a first current 06 having a configured amperage, voltage, and waveform.

The current embodiment includes a second plurality 30 of busbars 32 configured to receive a second current 08 having a second amperage, voltage, and/or waveform. The busbars 32 are also preferably planar and disposed within a second busway housing 31 in a generally parallel and spaced apart relationship. Each busbar 32 is optionally coated with an insulative layer 34 in order to prevent electrical contact or arcing between the busbars 32. Each busbar 32 also presents a centerline 36. In the exemplary embodiment, the second plurality 30 of busbars 32 share a similar second centerline-to-centerline spacing 38. The second centerline-to-centerline spacing 38, thickness, width, and composition of the second plurality 30 of busbars 32 are configured according to the second power source 08. Where the second power source is of higher amperage, the busbars 32 have a higher thickness or width. The bars are also preferably composed of copper or aluminum, but can be composed of other conductors known in the art.

The proximal ends of the second plurality 30 of busbars 32 are shaped to receive the second power source 08 or additional multiple power busway. The distal portions of the second plurality 30 of busbars 32 are configured to mate with additional multiple power busway, bus bridges, bus plugs, appliances, or similar devices. The busbars 32 include conductive fingers 29 and 39 in order to facilitate mating and electrical communication with other devices. Additionally, the busbar 32 spacing may change in order to facilitate engagement with other devices.

Housing 31 bounds the plurality 30 of busbars 32, presenting a barrier to external contact and optionally presenting a magnetic barrier. Housing 31 preferably includes a plurality of generally planar members although they may be shaped as required for a particular use. In these embodiments, housing 31 includes a generally planar top member 51, a generally planar bottom member 53, a generally planar first sidewall member 55, and a generally planar second sidewall member 57. The top member 51, bottom member 53, first sidewall member 55 and second sidewall member 57 are joined lengthwise to define an enclosed space wherein the pluralities 30 of busbars 32 may be enclosed. The members 51, 53, 55 and 57 may be joined in different configurations. For example, the members 51, 53, 55 and 57 can be extruded, welded, snap fit, hingedly joined, slidably joined, removably joined, mechanically fastened, or other methods of joinder. The members 51, 53, 55 and 57 are preferably composed of non-magnetic, heat dissipating material such as aluminum. One exemplary configuration is composed of aluminum and includes top member 51, sidewall member 55, and bottom member 53 extruded as a unitary member in a U-shaped configuration with the sidewall member 57 hingedly joined, operable as a replaceable cover. Additional disclosures of housing configurations are well known in the art. In the exemplary configuration of the current embodiment, a lip 18 extends outwardly from a housing member 51, 53, 55, or 57 lengthwise. The lip 18 is dimensioned to fill a portion of the interior of the channel 01 of the provided single source busway 05, facilitating slidable placement of the lip 18 through the channel 01. In this state, this embodiment is adjacent to the provided single source busway 05 with the housing member 51, 53, 55, or 57 abutting the face 07.

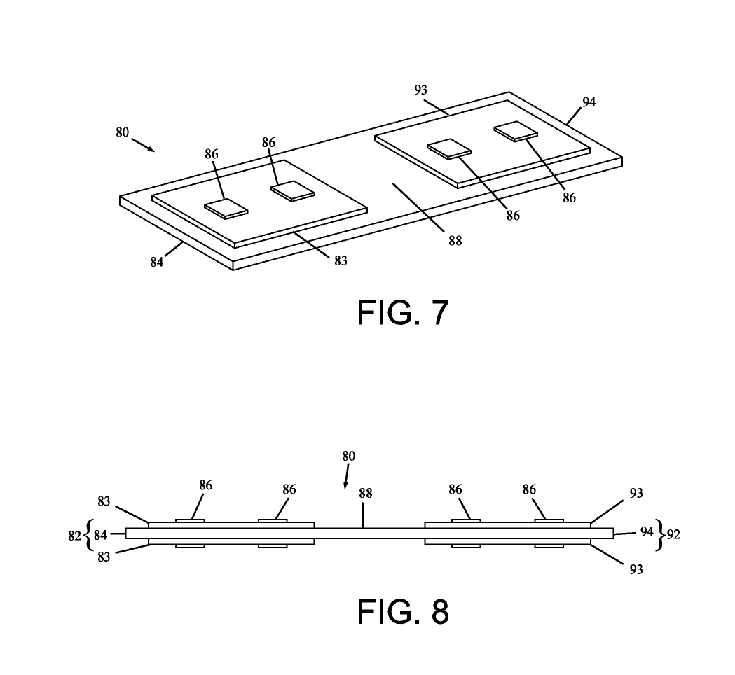

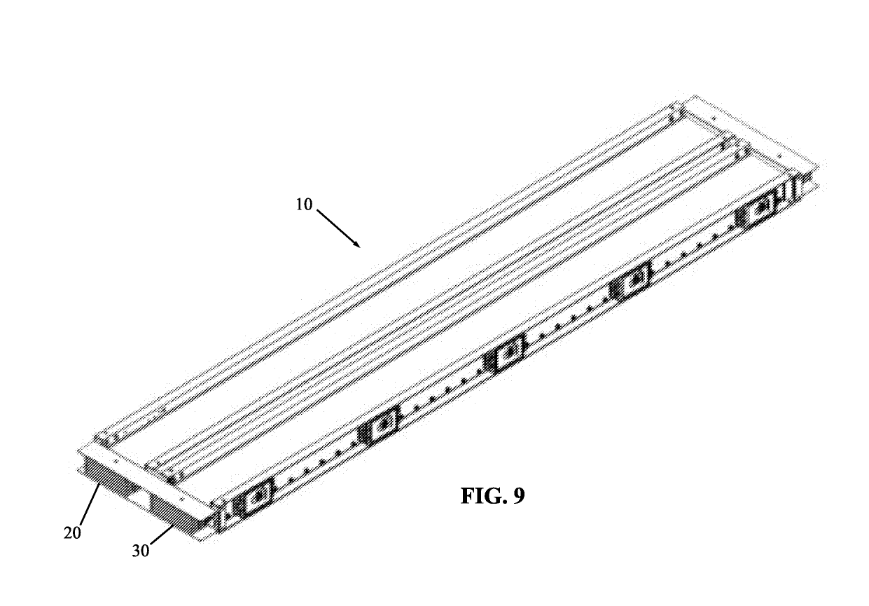

Now referring to FIGS. 7 and 8, splitter plate 80 operable to enable communication between a first and second length of multiple power busway are described. As previously mentioned in connection with the prior disclosed embodiments and illustrated in FIG. 9, the proximal or distal ends of the busway may be configured for mating with additional segments of busway in order to extend the distance of available power. A first length of multiple power busway system having a first plurality and a second plurality of conductive fingers on its distal end is provided. A second length of multiple power busway system having a similarly configured first plurality and a similarly configured second plurality of conductive fingers on its proximal end is provided for placement in an opposing relationship to the first length of multiple power busway system. For visual clarity, the splitter plate 80 of FIGS. 7 and 8 is configured to mate multiple power busway system having two conductive fingers in their first plurality and two conductive fingers in their second plurality.

Referring specifically to FIG. 8, the splitter plate 80 includes a first plurality 82 of conductor plates 83 and at least one insulating layer 84. The number of conductor plates 83 in the plurality equals that in the first plurality of conductive fingers of the provided multiple power busway system. The depicted configuration includes two conductor plates 83 with an insulating layer 84 disposed between them. The exemplary height of the “sandwiched” layers is slightly less than the centerline-to-centerline spacing of the first plurality of conductive fingers, facilitating slidable engagement and maintained communication. The exemplary conductor plates 83 include beveled edges, further facilitating slidable engagement with the conductive fingers. The sandwiched layers 83 84 and 83 are secured with fasteners 86. The exemplary fastener 86 includes a bolt, insulating sleeve, and raised region combination. A hole is disposed through each of the layers 83 84 and 83 of the sandwich. The holes of the conductors plates 83 are concentric and larger than the holes of the insulating layer 84. The insulating layer 84 includes a raised region concentrically disposed to the hole and dimensioned slightly smaller than the larger hole of the conductor plates 83 such that the raised region restricts movement of the conductor plates 83 relative to the insulating layer 84. The insulating sleeve is disposed through the hole of the insulating layer 84 for insertion of the bolt, further securing the sandwiched layers 83 84 and 83.

The splitter plate 80 includes a second plurality 92 of conductor plates 93 and at least one insulating layer 94. The number of conductor plates 93 in the plurality equals that in the second plurality of conductive fingers of the provided multiple power busway system. The depicted configuration includes two conductor plates 93 with an insulating layer 94 disposed between them. Again, the exemplary height of the “sandwiched” layers is slightly less than the centerline-to-centerline spacing 38 of the second plurality of conductive fingers. The exemplary conductor plates 93 also include beveled edges. The sandwiched layers 93 94 and 93 are secured with fasteners 86 as disclosed above.

The splitter plate 80 further includes a spacer 88 operable to maintain the relative position of the first plurality 82 of conductor plates 83 to the second plurality 92 of conductors plates 93 while electrically isolating them. The depicted spacer 88 is a planar member composed of rigid, insulative material spanning the first and second pluralities 82 and 92. In the depicted configuration, the insulating layers 84 and 94 and spacer 88 are unitary.

Now referring specifically to FIGS. 2B, 2C, and 5, an alternate use of the multiple power busway system 10 is described. FIG. 5 illustrates a possible power configuration at a facility. A main power distribution switchboard 70 receives power. It outputs power 06 to a first distribution switchboard 66 at a first amperage, voltage, and waveform. It outputs power 08 to a second distribution switchboard at a second amperage, voltage, and waveform. The multiple power source busway 10 receives input power from both sources 06 08. Referring to FIG. 2B, a user may append a component 60, such as a converter, to the distal portion of the first plurality 20 of busbars 22. The user may append a component 62, such as a converter, to the distal portion of the second plurality 30 of busbars 32. Referring to FIG. 2C, the user may apply an appliance 64 further downline. For example, the user may “stab” both outputs into an automatic transfer switch which monitors the availability of current from both power sources 06 08. When one power source is unavailable, the automatic transfer switch adjusts accordingly.

Although this invention has been described with reference to an illustrative embodiment, this description is not intended to limit the scope of the invention. Various modifications and combinations of the illustrative embodiments as well as other embodiments of the invention will be apparent to persons skilled in the art upon reference to the description. It is therefore intended that the appended claims accomplish any such modifications or embodiments.

We claim:

1. A bus way system comprising:
a first plurality of busbars in a spaced apart relationship, the width, thickness, and spacing of said busbars configured for receipt of a first power source;
said first plurality of busbars contained in a first housing;
a second plurality of busbars in a spaced apart relationship, the width, thickness, and spacing of said busbars configured for receipt of a second power source;
said second plurality of busbars contained in a second housing and electrically isolated from said first plurality; and
said first housing configured for adjacent placement to said second housing.

2. The device of claim 1 wherein said housings are chemically joined.

3. The device of claim 1 wherein said housings are mechanically joined.

4. The device of claim 3 wherein said housings are integrally joined.

5. The device of claim 3 wherein said housings are removably joined.

6. The device of claim 3 wherein said housings are slidably joined.

7. The device of claim 3 wherein said first housing includes a U-shaped section hingedly joined to a top section member, said second housing jointly incorporating said top section member of said first housing.

8. The device of claim 1 further comprising a splitter plate,
said splitter plate including a first plurality of conductor plates, a spacer, and a second plurality of conductor plates;
said first plurality of conductor plates comprised of alternating layers of conducting plates and insulation, the number of layers corresponding to the number of busbars in said first plurality of busbars, the layer height being about that of the centerline to centerline distance in said first plurality of busbars;
said second plurality of conductor plates comprised of alternating layers of conductor plates and insulation, the number of layers corresponding to the number of busbars in said second plurality of busbars, the layer height being about that of the centerline to centerline distance in said second plurality of busbars;
said spacer comprising a rigid, insulative member joined to said first plurality of conductive plates and distally joined to said second plurality of conductive plates, whereby said spacer maintains relative position of said pluralities of conductor plates.

9. A secondary bus way system for adjacent placement with a primary bus way system having a first housing with an outer face and encompassing a first plurality of busbars, said secondary bus way system comprising:
a second plurality of busbars in a spaced apart relationship, the width, thickness, and spacing of said busbars configured for receipt of a second power source;
said second plurality of busbars contained in a second housing and electrically isolated from said first plurality;
said second housing including a fastener for joinder to said face.

10. The device of claim 9, wherein said fastener is a chemical fastener.

11. The device of claim 9, wherein said fastener is a mechanical fastener.

12. The device of claim 11, wherein said mechanical fastener comprises a lip extending outwardly from said housing, operable for slidable engagement to a channel presented by said first housing.

13. The device of claim 9 further comprising a splitter plate,
said splitter plate including a first plurality of conductor plates, a spacer, and a second plurality of conductor plates;
said first plurality of conductor plates comprised of alternating layers of conducting plates and insulation, the number of layers corresponding to the number of busbars in said first plurality of busbars, the layer height being about that of the centerline to centerline distance in said first plurality of busbars;
said second plurality of conductor plates comprised of alternating layers of conductor plates and insulation, the number of layers corresponding to the number of busbars in said second plurality of busbars, the layer height being about that of the centerline to centerline distance in said second plurality of busbars;
said spacer comprising a rigid, insulative member joined to said first plurality of conductive plates and distally joined to said second plurality of conductive plates, whereby said spacer maintains relative position of said pluralities of conductor plates.
